(19) United States
(12) Patent Application Publication
(10) Pub. No.: US 2014/0096205 A1
(43) Pub. Date: Apr. 3, 2014

(54) Login method, open platform identification method, open platform and open platform system

(71) Applicant: TENCENT TECHNOLOGY (SHENZHEN) COMPANY LIMITED, Shenzhen (CN)

(72) Inventors: Sihua Zhuang, Shenzhen (CN); Huanyu Zhou, Shenzhen (CN); Dingfen Long, Shenzhen (CN); Xueheng Guo, Shenzhen (CN); Jin Zhang, Shenzhen (CN); Zhiyong Fang, Shenzhen (CN); Shunan Yu, Shenzhen (CN); Jiangde Dong, Shenzhen (CN); Qiming Xie, Shenzhen (CN); Yangtao Ma, Shenzhen (CN); Ning Lao, Shenzhen (CN)

(73) Assignee: TENCENT TECHNOLOGY (SHENZHEN) COMPANY LIMITED, Shenzhen (CN)

(21) Appl. No.: 14/098,085

(22) Filed: Dec. 5, 2013

Related U.S. Application Data
(63) Continuation of application No. PCT/CN2012/085185, filed on Nov. 23, 2012.

(30) Foreign Application Priority Data
Nov. 23, 2011 (CN) 2011103758633
Nov. 23, 2011 (CN) 2011103763434

(51) Int. Cl. H04L 29/06

(52) U.S. Cl. CPC H04L 63/10
USPC 726/4

(57) ABSTRACT

The disclosure provides a login method, an open platform identification method, an open platform and an open platform system. A user terminal is guided to agree to authorize a third party application via a page of the open platform; when the connection of authorization of the user terminal succeeds, the open platform brings a first OpenID and a first OpenKey of the user to the third party application according to a login rebound protocol of the open platform; then the third party application performs user-terminal-based authorized login according to the first OpenID and the first OpenKey; and when the user terminal logging into the open platform initiates the third party application, a prompt message is sent to the user terminal with an open platform account serving as an identification of the open platform, and thus login can be implemented in various forms. A user does not need to register or manage login accounts of a plurality of websites and meanwhile the prompt and push problem of the third party application is solved.

### CROSS REFERENCE TO RELATED APPLICATIONS

This is a continuation application of International Patent Application No.: PCT/CN2012/085185, filed on Nov. 23, 2012, which claims priority to Chinese Patent Applications No.: 201110376343.4 and 201110375863.3 both filed on Nov. 23, 2011, the disclosure of which is incorporated by reference herein in its entirety

### TECHNICAL FIELD

The disclosure relates to the field of open platform, and in particular to a login method, an open platform identification method, an open platform and an open platform system.

### BACKGROUND

In existing technology, when a user logs in a website, the user generally needs to register a login account on this website and sets a corresponding login password. The account registered on website A by a user can be used to log in the website A only, but can not be used to log in website B. Therefore, if a user needs to log in a plurality of websites, the user needs to register corresponding accounts, thus a plurality of accounts need to be managed and inconvenience is caused to the user.

There also is a condition to access the account of a user registered website through a third party application website. However, considering safety and user privacy, if the user needs to access the third party application website, it is necessary for an open platform of a registered website to authorize the third party application website, that is to say, when the user accesses the third party application without logging in or the third party application is not authorized, the open platform of the registered website would not transmit related parameters of the user to the third party application; at this time, the third party application can not access basic data of the user such as personal information. If the third party application can not provide services to the user without acquiring the basic data of the user, then the user is not allowed to access resources provided by the third party application and not allowed to enjoy services provided by the third party application. Take a Sohu MicroBlog account for example, if a third party application requests to access the Sohu MicroBlog account of a user, then, after authorizing the access right of this account to the third party application, the user can use the relevant function of the Sohu MicroBlog in the third party application, and the third party application also can access and update related data of the MicroBlog of the user.

However, the existing authorized login method of third party application is complicated at implementation and can not meet the requirements of users. Moreover, the instant communication open platform, serving as a client platform system, has a problem in the implementation of prompt. The operation and maintenance centre of the application which needs to send a prompt message is unaware of which open platform the user runs on currently, that is to say, the operation and maintenance centre does not know which platform the message should be transmitted to.

### SUMMARY

The main purpose of the disclosure is to provide a login method, an open platform and an open platform system which are easy to be implemented and are convenient for a user to log in a plurality of websites.

In order to achieve the purpose above, the disclosure provides a login method, including:

an open platform enters a page to receive an authorization instruction for a third party application from a user terminal;

when connection of authorization of the user terminal succeeds, a first login identification (OpenID) and a first login key (OpenKey) of the user terminal are sent to the third party application according to a preset login rebound protocol of the open platform; and the third party application performs user-terminal-based authorized login according to the first OpenID and the first OpenKey; and

when the user terminal logging into the open platform initiates the third party application, a prompt message is sent to the user terminal with an open platform account serving as an identification of the open platform.

In the scheme above, the method may further include:

after the first OpenID and the first OpenKey of the user are sent to the third party application,

verification is performed on the validity of the third party application according to the first OpenID and the first OpenKey; if the verification succeeds, it is indicated the authorized login of the third party application succeeds.

In the scheme above, the step that verification is performed on the validity of the third party application according to the first OpenID and the first OpenKey may include:

a verification request is received from the third party application, wherein the verification request carries the first OpenID and the first OpenKey; and

verification is performed on the validity of the first OpenID and the first OpenKey carried in the verification request.

In the scheme above, the method may further include:

after the verification succeeds, the open platform returns user authorization data to the third party application.

In the scheme above, the method may further include: before the first OpenID and the first OpenKey of the user terminal are sent to the third party application according to a preset login rebound protocol of the open platform,

the open platform generates an initial OpenID and an initial OpenKey according to a login account of the user terminal; and

according to a preset mapping relationship, the initial OpenID and the initial OpenKey are converted into the first OpenID and the first OpenKey correspondingly.

In the scheme above, the open platform may enter the page according to an application login instruction of the user terminal; or

the user terminal may log in the third party application and the third party application may call an interface of the open platform, so as to make the open platform enter the page.

In the scheme above, when the user terminal logging into the open platform initiates the third party application, the process of identifying the open platform may include:

when the user terminal logging into the open platform initiates the third party application, the open platform acquires an open platform account which is generated according to an application ID (AppID) of the third party application and a platform login account of the user terminal, the open platform account is sent to the third party application, a notification instruction is received from the third party application, and on behalf of the third party application a prompt message corresponding to the notification instruction is sent to the user terminal according to the open platform account carried in the notification instruction.

The disclosure provides a login open platform, including: a guide module, a sending module and a platform identification module,

wherein the guide module is configured to enter a page to receive an authorization instruction for a third party application from a user terminal,

wherein the sending module is configured to send a first OpenID and a first OpenKey of the user terminal to the third party application according to a login rebound protocol of the open platform when connection of authorization of the user terminal succeeds, so that the third party application performs user-terminal-based authorized login according to the first OpenID and the first OpenKey, and

the platform identification module is configured to send a prompt message to the user terminal with an open platform account serving as an identification of the open platform, when the user terminal logging into the open platform initiates the third party application.

In the scheme above, the open platform may further include:

a verification module, which is configured to verify the validity of the third party application according to the first OpenID and the first OpenKey; if the verification succeeds, it is indicated the authorized login of the third party application succeeds.

In the scheme above, the verification module may be further configured to receive a verification request sent from the third party application, the verification request carrying the first OpenID and the first OpenKey, and to verify the validity of the first OpenID and the first OpenKey carried in the verification request.

In the scheme above, the verification module may be further configured to return user authorization data to the third party application after the verification succeeds.

In the scheme above, the open platform may further include:

a generation-conversion module, which is configured to generate an initial OpenID and an initial OpenKey according to a login account of the user terminal, and to convert the initial OpenID and the initial OpenKey into the first OpenID and the first OpenKey correspondingly according to a preset mapping relationship.

In the scheme above, the platform identification module may include: an acquisition module, a sending module and a prompt module,

wherein the acquisition module is configured to acquire an open platform account which is generated according to an AppID of the third party application and a platform login account of the user terminal, when the user terminal logging into the open platform initiates the third party application,

wherein the sending module is configured to send the open platform account to the third party application, and

wherein the prompt module is configured to receive a notification instruction sent by the third party application, and to send, on behalf of the third party application, a prompt message corresponding to the notification to the user terminal according to the open platform account carried in the notification instruction.

The disclosure provides a login system, including: a user terminal, an open platform and a third party application,

wherein the user terminal is configured to link to the open platform and to send an authorization instruction for the third party application to the open platform, and to receive access resources and services provided by the third party application when the authorized login of the third party application succeeds,

wherein the open platform is configured to enter a page to receive the authorization instruction for the third party application from the user terminal, to send a first OpenID and a first OpenKey of the user terminal to the third party application according to a preset login rebound protocol of the open platform when connection of authorization of the user terminal succeeds, and to send a prompt message to the user terminal with an open platform account serving as an identification of the open platform when the user terminal logging into the open platform initiates the third party application, and

wherein the third party application is configured to receive the first OpenID and the first OpenKey sent by the open platform, to send a login status according to the first OpenID and the first OpenKey, so as to allow the user terminal to access resources of the third party application and provide site services for the user terminal.

In the scheme above,

the open platform may be further configured to verify the validity of the third party application according to the first OpenID and the first OpenKey; if the verification succeeds, it is indicated the authorized login of the third party application succeeds,

the third party application may be further configured to be subject to validity verification on the first OpenID and the first OpenKey by a local server, or, the third party application may be configured to be subject to the validity verification on the first OpenID and the first OpenKey by the open platform.

In the scheme above,

the third party application may be further configured to send to the open platform a verification request to acquire user authorization data, the verification request carrying the first OpenID and the first OpenKey, and to receive the user authorization data returned by the open platform after the open platform verifies the OpenID and the first OpenKey are valid.

In the scheme above,

the third party application may be further configured to receive an application login instruction from a client, and to call, according to the application login instruction, an interface of the open platform so as to open a page of the open platform.

In the scheme above, the open platform may be configured to:

acquire an open platform account which is generated according to an AppID of the third party application and a platform login account of the user terminal, when the user terminal logging into the open platform initiates the third party application;

send the open platform account to the third party application;

receive a notification instruction sent by the third party application, and send, on behalf of the third party application, a prompt message corresponding to the notification to the user terminal according to the open platform account carried in the notification instruction.

The disclosure provides an open platform identification method, including:

when a user terminal logging into an open platform initiates a third party application, the open platform acquires an open platform account which is generated according to an AppID of the third party application and a platform login account of the user terminal;

the open platform account is sent to the third party application; and

a notification instruction is received from the third party application, and on behalf of the third party application a prompt message corresponding to the notification instruction is sent to the user terminal according to the open platform account carried in the notification instruction.

In the scheme above, the step that the open platform acquires an open platform account which is generated according to an AppID of the third party application and a platform login account of the user terminal may include:

the open platform acquires the open platform account from cache; or

the open platform generates a temporary open platform account through a preset algorithm according to the platform login account of the user terminal and the AppID of the third party application.

In the scheme above, the step that the open platform sends, on behalf of the third party application, a prompt message corresponding to the notification instruction to the user terminal according to the open platform account carried in the notification instruction may include:

the open platform searches locally for the platform login account of the user terminal corresponding to the open platform account carried in the notification instruction; and

the prompt message corresponding to the notification instruction is sent to the user terminal according to the platform login account of the user terminal.

In the scheme above, the step that the open platform sends, on behalf of the third party application, a prompt message corresponding to the notification instruction to the user terminal according to the open platform account carried in the notification instruction may include:

the open platform searches locally for the platform login account of the user terminal and the AppID of the third party application corresponding to the open platform account carried in the notification instruction; and

verification is performed on the AppID of the third party application;

the prompt message corresponding to the notification instruction is sent to the user terminal according to the platform login account of the user terminal, after the verification succeeds.

The disclosure provides an open platform, including a platform identification module, wherein the platform identification module includes: an acquisition module, a sending module and a prompt module,

wherein the acquisition module is configured to acquire an open platform account which is generated according to an AppID of a third party application and a platform login account of a user terminal, when the user terminal logging into the open platform initiates the third party application,

wherein the sending module is configured to send the open platform account to the third party application, and

wherein the prompt module is configured to receive a notification instruction sent by the third party application, and to send, on behalf of the third party application, a prompt message corresponding to the notification instruction to the user terminal according to the open platform account carried in the notification instruction.

In the scheme above, the acquisition module may be further configured to acquire the open platform account from cache, or, the acquisition module may be configured to generate a temporary open platform account through a preset algorithm according to the platform login account of the user terminal and the AppID of the third party application.

In the scheme above, the prompt module may include:

a searching unit, configured to search locally for the platform login account of the user terminal corresponding to the open platform account carried in the notification instruction; and

a sending unit, configured to send the prompt message corresponding to the notification instruction to the user terminal according to the platform login account of the user terminal.

In the scheme above, the prompt module may further include a verification unit,

the searching unit may be further configured to search locally for the platform login account of the user terminal and the AppID of the third party application corresponding to the open platform account carried in the notification instruction;

the verification unit may be configured to verify the AppID of the third party application, and

the sending unit may be further configured to send the prompt message corresponding to the notification instruction to the user terminal according to the platform login account of the user terminal, after the verification succeeds.

The disclosure provides an open platform identification system, including an open platform and a third party application,

the open platform is configured to: acquire an open platform account which is generated according to an AppID of the third party application and a platform login account of a user terminal, when the user terminal logging into the open platform initiates the third party application; send the open platform account to the third party application; receive a notification instruction sent by the third party application, and send, on behalf of the third party application, a prompt message corresponding to the notification instruction to the user terminal according to the open platform account carried in the notification instruction,

the third party application is configured to: receive the open platform account sent by the open platform and record a relationship between the third party login account of the user terminal and the open platform account, when the user terminal logs in the third party application; acquire the open platform account according to the third party login account of the user terminal and provide a notification to the open platform, when the third party application needs to send the notification to the user terminal.

The disclosure provides a login method, an open platform identification method, an open platform and an open platform system. A user terminal is guided to agree to authorize a third party application via a page of the open platform; when the connection of authorization of the user terminal succeeds, the open platform brings a first OpenID and a first OpenKey of the user to the third party application according to a login rebound protocol of the open platform; then the third party application performs user-terminal-based authorized login according to the first OpenID and the first OpenKey; and when the user terminal logging into the open platform initiates the third party application, a prompt message is sent to the user terminal with an open platform account serving as an identification of the open platform, and thus login can be implemented in various forms. Therefore, the user does not need to register or manage login accounts of a plurality of websites, but needs one registered account on an open platform only to access a plurality of websites after authorization, and thus convenience is provided to the user; meanwhile, the prompt and push problem of the third party application is solved, and the interference problem caused by cross-platform application is prevented.

### BRIEF DESCRIPTION OF THE DRAWINGS

FIG. 1 shows a flowchart of a first embodiment of a login method provided by the disclosure;

FIG. 2 shows a flowchart of Step 103 shown in FIG. 1 of the disclosure;

FIG. 3 shows a flowchart of a first example of Step 203 shown in FIG. 2 of the disclosure;

FIG. 4 shows a flowchart of a second example of Step 203 shown in FIG. 2 of the disclosure;

FIG. 5 shows a flowchart of a second embodiment of a login method provided by the disclosure;

FIG. 6 shows a flowchart of a first example of the second embodiment of the login method provided by the disclosure;

FIG. 7 shows a flowchart of a second example of the second embodiment of the login method provided by the disclosure;

FIG. 8 shows a structure diagram of a first embodiment of an open platform provided by the disclosure;

FIG. 9 shows a structure diagram of a second embodiment of an open platform provided by the disclosure;

FIG. 10 shows a structure diagram of a platform identification module included in an open platform provided by the disclosure;

FIG. 11 shows a structure diagram of a first example of a prompt module included in the platform identification module of the disclosure;

FIG. 12 shows a structure diagram of a second example of a prompt module included in the platform identification module of the disclosure;

FIG. 13 shows a structure diagram of an embodiment of a login system of the disclosure; and

FIG. 14 shows a structure diagram of an embodiment of an open platform identification system of the disclosure.

### DETAILED DESCRIPTION

The operating environment for the methods of the embodiments of the disclosure involves an open platform, a third party application site (hereinafter called third party application) and a user-oriented client (called user terminal in the following embodiments). The user terminal has registered a login account and a corresponding password on the open platform, the user thus can perform instant-communication login in the open platform through the registered login account and the corresponding password. In the disclosure, the user terminal authorizes the third party application through the open platform, thereby implementing the third-party authorized login of instant communication.

Technical terms involved in the embodiments of the disclosure include the followings

AppID: it is a unique identification of an application. Application Program (APP) basic information can be found through the AppID. The AppID is allocated uniformly by the open platform when the third party application performs registration.

AppSecret: when the user terminal logs in the third party application in an instant communication mode and when the open platform returns an OpenKey to the third party application, in order to ensure the safety of communication between a server of the third party application and a server of the open platform, to avoid malicious use of a communication channel and to guarantee the authority of the third party application, it is needed to add a signature mechanism using the AppSecret during communication. The AppSecret is unique and not published, and is known by the open platform and the third party application only.

OpenID: it is a user ID used for communicating with the third party application, and is corresponding to the instant communication number of the use terminal. The third party application must carry the OpenID when accessing the OpenAPI.

OpenKey: it is a verification character string for the communication of the third party application, and the third party application must carry the OpenKey when accessing the OpenAPI.

OpenAPI: it is a programming interface provided by the open platform for the access of the third party application.

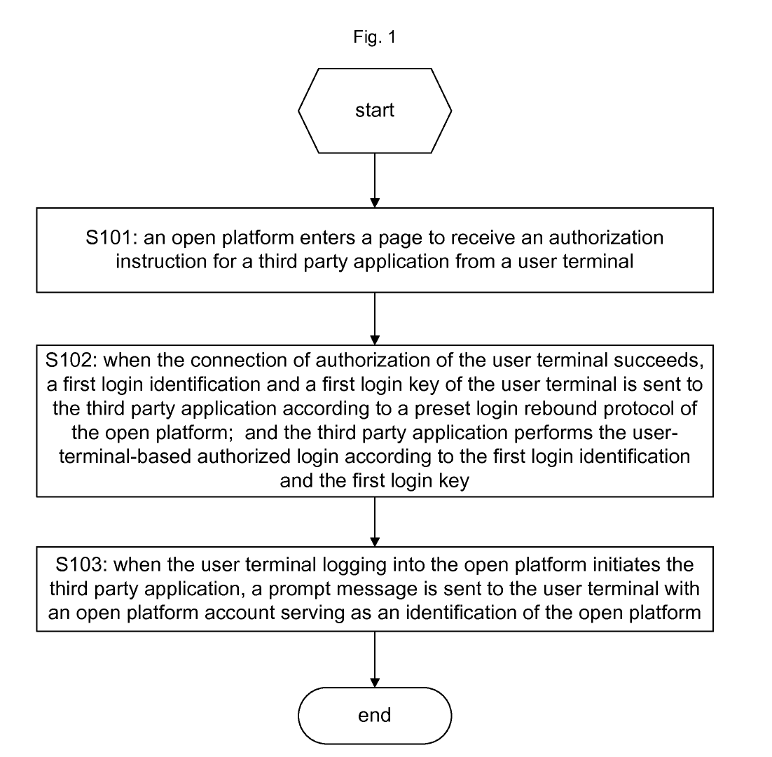

As shown in FIG. 1, the first embodiment of the disclosure provides a login method, which includes the following steps.

Step 101: an open platform enters a page to receive an authorization instruction for a third party application from a user terminal.

The page that the open platform enters is an authorization page. The open platform may enter the authorization page according to an application login instruction of the user terminal. The application login instruction might be a voice instruction, also might be a control set by the open platform for allowing the user terminal to access the third party application, for example, the user might click an APP application button of a client to enter the authorization page. Alternatively, the user terminal may log in the third party application (for example, the user enters the third party application by clicking a login button on the third party application) and then the third party application calls an interface of the open platform, so as to make the open platform enter the authorization page, wherein the interface might be a javascript Application Programming Interface (js API).

After the open platform enters the authorization page, the open platform guides the user terminal to agree to authorize the third party application.

Step 102: when the connection of authorization of the user terminal succeeds, a first login identification (OpenID) and a first login key (OpenKey) of the user terminal is sent to the third party application according to a preset login rebound protocol of the open platform; and the third party application performs the user-terminal-based authorized login according to the first OpenID and the first OpenKey.

When the user terminal agrees the authorization and the connection of authorization of the user terminal succeeds, the open platform opens, according to a preset login rebound protocol of the open platform, a login success page of the third party application to notify the third party application that the user terminal agrees the authorization, along with the first OpenID and the first OpenKey sent by the open platform to the third party application.

After the third party application receives the first OpenID and the first OpenKey transmitted from the open platform, the third party application performs authorization login. After the authorization login succeeds, the third party application sends a login status, so as to allow the user to access resources provided by the third party application and allow the user to enjoy services provided by the third party application.

Step 103: when the user terminal logging into the open platform initiates the third party application, a prompt message is sent to the user terminal with an open platform account serving as an identification of the open platform.

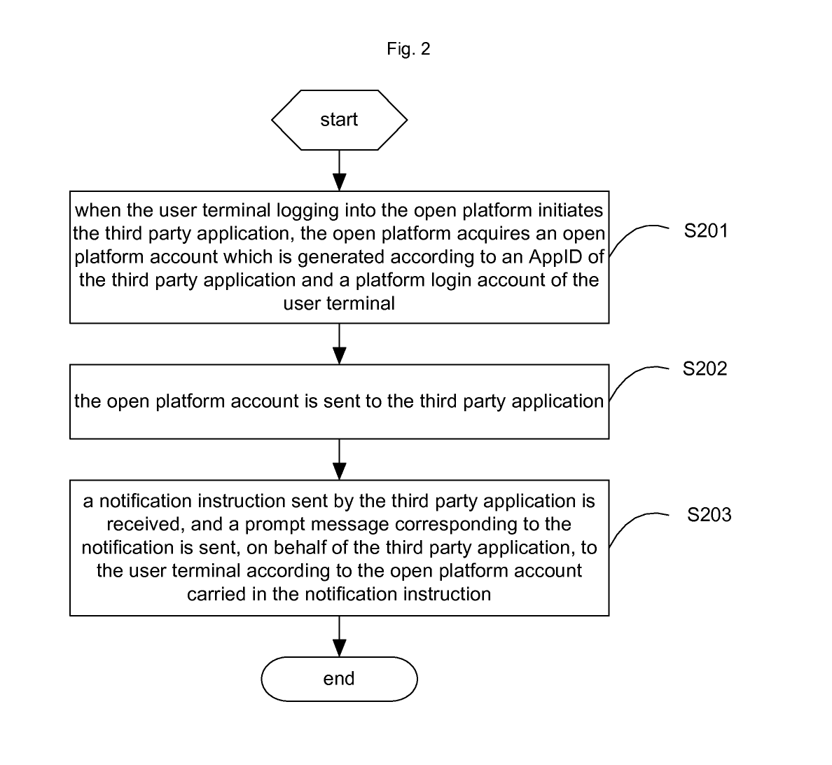

Step 103, as shown in FIG. 2, specifically includes the followings.

Step 201: when the user terminal logging into the open platform initiates the third party application, the open platform acquires an open platform account which is generated according to an AppID of the third party application and a platform login account of the user terminal.

In this embodiment, the open platform might be an instant communication open platform, for example, QQ open platform and the like. The user logs in the open platform through the platform login account on a PC or a mobile phone (an IPhone). The platform login account serves as the identification for allowing the user to log in the open platform. After the user logs in the open platform, the user may click a third party application running on this open platform based on actual needs, so as to acquire corresponding services or resources.

In order to identify the open platform, an embodiment sets a parameter, i.e. an open platform account (hereinafter expressed as QplusID) associating the third party application with the user terminal. This parameter QPlusID is generated by the open platform according to the platform login account of the user terminal and the AppID of the third party application.

Each user terminal has a platform login account on the open platform. The third party application on each open platform has a corresponding AppID. The QPlusID generated by the open platform according to the platform login account of the user terminal and the AppID of the third party application serves as the identification of the open platform, so that the third party application can send a message to the corresponding open platform according to the QPlusID when it wants to make a prompt through the open platform.

The open platform may adopt a preset algorithm to generate the QPlusID according to the platform login account of the user terminal and the AppID of the third party application. For example, the open platform can concatenate the platform login account of the user terminal and the AppID of the third party application together to generate the QPlusID, through existing symmetrical encryption algorithms such as Tiny Encryption Algorithm (TEA), Data Encryption Standard (DES) and International Data Encryption Algorithm (IDEA). The above symmetrical encryption algorithms belong to existing mature schemes and no further description is repeated here.

The QPlusID generated by the open platform according to the platform login account of the user terminal and the AppID of the third party application may be generated in advance and saved in a local cache, or may be generated temporarily.

After the user terminal logs in the open platform and initiates the third party application, if the cache of the open platform has a corresponding QPlusID, then the open platform acquires the corresponding QPlusID directly; if the cache has no corresponding QPlusID, then the open platform triggers its background server to generate a QPlusID according to information such as the platform login account of the user terminal and the AppID of the third party application.

Step 202: the open platform account is sent to the third party application.

After the open platform acquires the QPlusID associating the third party application with the user terminal, the open platform notifies the third party application to acquire the QPlusID. After the third party application acquires through its front end the QPlusID sent from the open platform, the third party application logs in a background server of the third party application and sends the acquired QPlusID to the background server of the third party application for saving. The background server of the third party application also saves the relationship between the login account of the user terminal on the third party application (that is, the third party login account referred in this embodiment) and the QPlusID, so that the third party application can provide the QPlusID to the open platform when needing the open platform to transmit a prompt message to the user terminal.

Step 203: a notification instruction sent by the third party application is received, and a prompt message corresponding to the notification is sent, on behalf of the third party application, to the user terminal according to the open platform account carried in the notification instruction.

At a certain point, when the background server of the third party application needs to notify the front end of the third party application, the front end of the third party application might be in an online state or an offline state. The background server of the third party application searches out from a locally saved list the QPlusID corresponding to the third party login account of the user terminal and specifies the corresponding QPlusID when making a request to an interface of the prompt centre of the open platform. The prompt centre of the open platform inquires the background server of the open platform about the platform login account of the user terminal and the AppID of the third party application, in this way, the prompt centre of the open platform learns the destination of the prompt message, and verifies whether the AppID of the third party application is correct, so as to prevent malicious access or interference caused by cross-platform application.

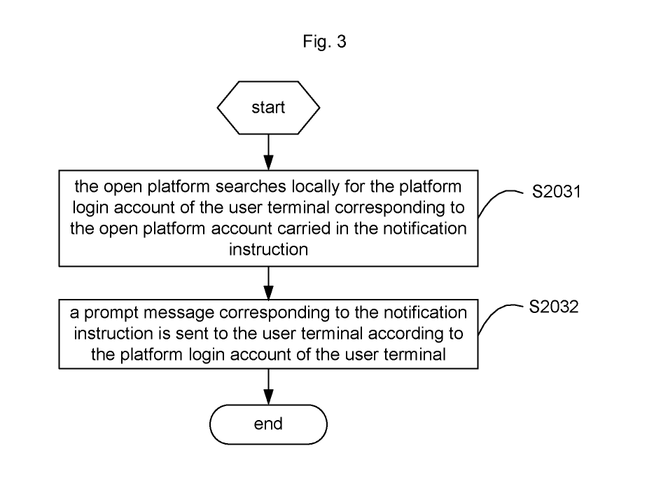

During specific implementation, as shown in FIG. 3, Step 203 serving as an implementation where the open platform performs message prompt includes the following steps.

Step 2031: the open platform searches locally for the platform login account of the user terminal corresponding to the open platform account carried in the notification instruction.

The open platform searches locally for the platform login account of the user terminal corresponding to the QPlusID provided by the third party application.

Step 2032: a prompt message corresponding to the notification instruction is sent to the user terminal according to the platform login account of the user terminal.

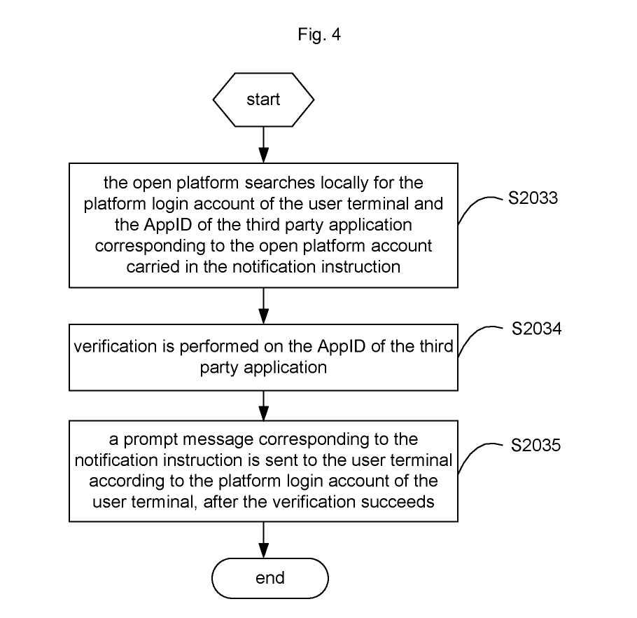

As shown in FIG. 4, Step 203 serving as another implementation where the open platform performs message prompt includes the following steps.

Step 2033: the open platform searches locally for the platform login account of the user terminal and the AppID of the third party application corresponding to the open platform account carried in the notification instruction.

The open platform searches locally for the platform login account of the user terminal and the AppID of the third party application corresponding to the QPlusID provided by the third party application.

Step 2034: verification is performed on the AppID of the third party application.

Step 2035: a prompt message corresponding to the notification instruction is sent to the user terminal according to the platform login account of the user terminal, after the verification succeeds.

In this step, after the user terminal logs in the open platform, if the user terminal initiates the third party application, then the open platform sends to the third party application the open platform account which is generated according to the AppID of the third party application and the platform login account of the user terminal. When the third party application needs to send a notification to the user, the open platform transmits, on behalf of the third party application, a prompt message to the user according to the open platform account specified by the third party application, thus the prompt and push problem of the third party application is solved and the interference problem caused by cross-platform application is avoided.

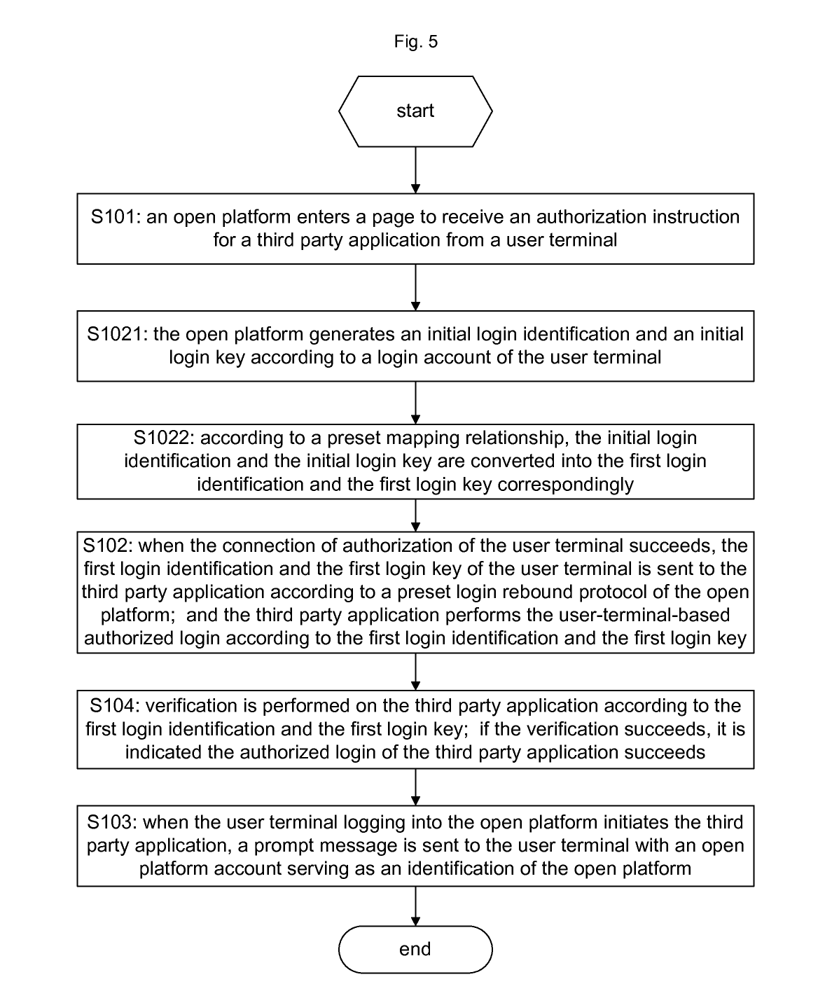

As shown in FIG. 5, the second embodiment of the disclosure provides a login method, which further includes the following steps on the basis of the first embodiment.

Step 1021: the open platform generates an initial OpenID and an initial OpenKey according to a login account of the user terminal.

Step 1022: according to a preset mapping relationship, the initial OpenID and the initial OpenKey are converted into the first OpenID and the first OpenKey correspondingly.

Steps 1021-1022 are prior to Step 102.

After Step 102, the method further includes Step 104.

Step 104: verification is performed on the third party application according to the first OpenID and the first OpenKey. If the verification succeeds, it is indicated the authorized login of the third party application succeeds.

The difference between the second embodiment and the first embodiment lies in that: in the second embodiment, the first OpenID and the first OpenKey sent to the third party application by the open platform are converted from the initial OpenID and the initial OpenKey through a preset mapping relationship.

Specifically, after the user terminal logs in and the open platform guides the user terminal to agree to authorize the third party application, the open platform generates the initial OpenID and the initial OpenKey according to the login account of the user terminal, and converts the initial OpenID and the initial OpenKey into the first OpenID and the first OpenKey according to the preset mapping relationship, thereby enhancing the safety of the third-party authorized login.

In addition, in this embodiment, after the third party application receives the first OpenID and the first OpenKey from the open platform, the third party application performs validity authentication according to the first OpenID and the first OpenKey, wherein the specific authentication process includes two conditions as follows.

The first condition is that: the third party application performs the validity authentication locally; specifically, the third party application is subject to the validity authentication on the first OpenID and the first OpenKey by a local server.

The second condition is that: the third party application is subject to the validity authentication on the first OpenID and the first OpenKey by the open platform.

In the second condition above, the authentication process specifically includes: the third party application sends to the open platform a verification request which carries the first OpenID and the first OpenKey, and then the open platform performs the validity verification on the first OpenID and the first OpenKey included in the verification request sent from the third party application; after the verification succeeds, it is indicated that the authorized login of the third party application succeeds, and the third party application sends a login status, so as to allow the user terminal to access resources provided by the third party application and allow the user terminal to enjoy services provided by the third party application.

During the process where the third party application is subject to the validity authentication on the first OpenID and the first OpenKey by the open platform, if the third party application needs to acquire the authorization data of the user, then the third party application carries through the local server the first OpenID and the first OpenKey to the background server of the open platform to acquire the authorization data of the user; after the open platform successfully authenticates the validity of the first OpenID and the first OpenKey, the open platform returns the authorization data of the user to the third party application.

Hereinafter, the process of two authorized login methods of the open platform in the embodiments of the disclosure is described in detail through specific examples.

### Example 1

### In the Scene where the Open Platform has a Login Status

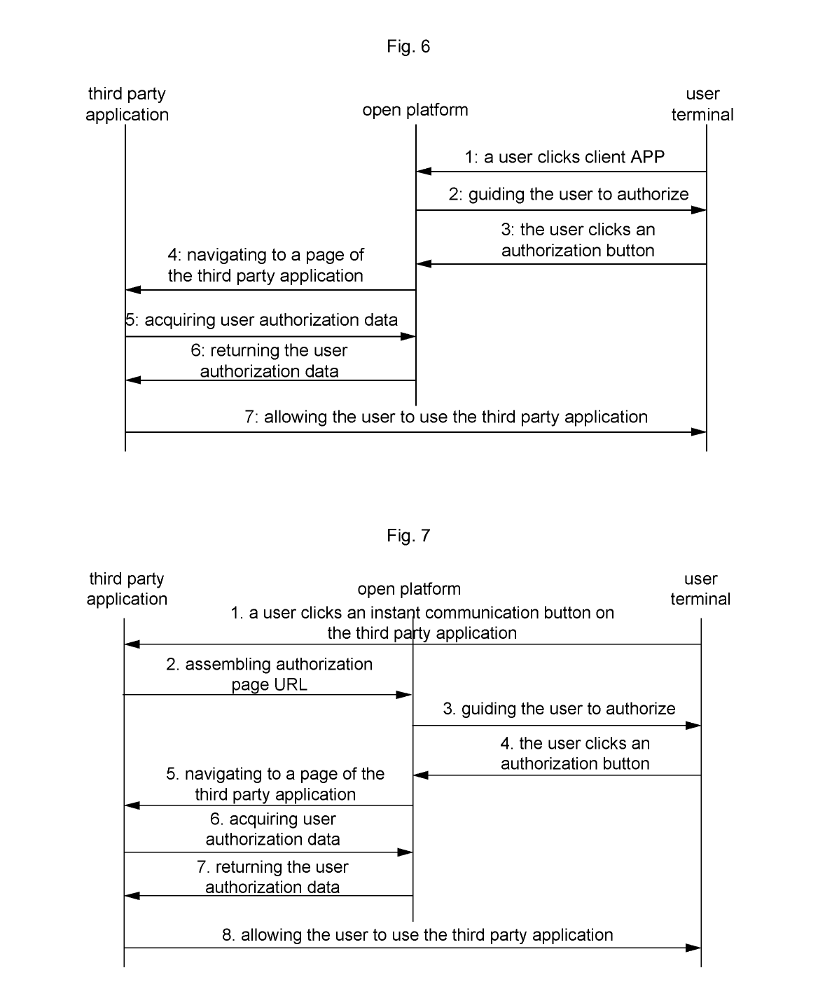

As shown in FIG. 6, the user terminal performs login using an OpenID, wherein the specific process includes:

1. the user terminal sends an application login instruction to the open platform;
2. the open platform returns an authorization page and guides the user terminal to agree authorization;
3. the user terminal agrees the authorization;
4. when the connection of authorization of the user terminal succeeds, the open platform opens, according to a login rebound protocol of the open platform, a login success page of the third party application with the first OpenID and the first OpenKey carried;
5. the third party application sends through the local server the first OpenID and the first OpenKey to the background server of the open platform to acquire the user authorization data. If the third party application does not need the user authorization data, Step 5 and Step 6 are omitted, going to Step 7 directly;
6. after the open platform successfully verifies the validity of the first OpenID and the first OpenKey, the open platform returns the user authorization data to the third party application; and
7. The third party application sends a login status to the user terminal, so as to allow the user terminal to access resources provided by the third party website and to enjoy services provided by the website.

### Example 2

### In the Scene where the Open Platform has no Login Status

As shown in FIG. 7, the user terminal selects an OpenID or a service account to perform login, wherein the specific process includes:

1. the user logs in the third party application and performs instant-communication login in the third party application;
2. the third party application calls a front end js API provided by the open platform to open the authorization page of the open platform;
3. the open platform guides the user to perform login using an instant-communication account and a password, and guides the user terminal to agree the authorization of the third party application;
4. the user terminal agrees the authorization;
5. when the connection of authorization of the user terminal succeeds, the open platform notifies, according to a login rebound protocol of the open platform, the third party application whether the user authorization succeeds, with the first OpenID and the first OpenKey carried;
6. the third party application acquires the user authorization data from the open platform, according to the login rebound protocol of the open platform;
7. after the open platform verifies the validaty of the first OpenID and the first OpenKey, the open platform returns the user authorization data to the third party application; and
8. the third party application sends a login status to the user terminal, so as to allow the user terminal to access resources provided by the third party website and to enjoy services provided by the website.

Through the technical schemes provided by the embodiments, the user terminal can log in the authorized website (third party application) with one account after the open platform is authorized by the open platform, thereby achieving the purpose of logging in a plurality of websites with one account; and thus convenience is provided to users and user experience is improved.

Based on the login methods above, the disclosure also provides an open platform identification method shown in FIG. 2, including the following steps.

Step 201: when a user terminal logging into an open platform initiates a third party application, the open platform acquiries an open platform account which is generated according to an AppID of the third party application and a platform login account of the user terminal.

In this embodiment, the open platform might be an instant communication open platform, for example, QQ open platform and the like. The user logs in the open platform through the platform login account on a PC or a mobile phone (an IPhone). The platform login account serves as an identification for allowing the user to log in the open platform. After the user logs in the open platform, the user may click a third party application running on this open platform based on actual needs, so as to acquire corresponding services or resources.

In order to identify the open platform, an embodiment sets a parameter, i.e. an open platform account (hereinafter expressed as QplusID) associating the third party application with the user terminal. This parameter QPlusID is generated by the open platform according to the platform login account of the user terminal and the AppID of the third party application.

Each user terminal has a platform login account on the open platform. The third party application on each open platform has a corresponding AppID. The QPlusID generated by the open platform according to the platform login account of the user terminal and the AppID of the third party application serves as the identification of the open platform, so that the third party application can send a message to the corresponding open platform according to the QPlusID when it wants to make a prompt through the open platform.

The open platform may adopt a preset algorithm to generate the QPlusID according to the platform login account of the user terminal and the AppID of the third party application. For example, the open platform can concatenate the platform login account of the user terminal and the AppID of the third party application together to generate the QPlusID, through existing symmetrical encryption algorithms such as TEA, DES and IDEA. The above symmetrical encryption algorithms belong to existing mature schemes and no further description is repeated here.

The QPlusID generated by the open platform according to the platform login account of the user terminal and the AppID of the third party application may be generated in advance and saved in a local cache, or may be generated temporarily.

After the user terminal logs in the open platform and initiates the third party application, if the cache of the open platform has a corresponding QPlusID, then the open platform acquires the corresponding QPlusID directly; if the cache has no corresponding QPlusID, then the open platform triggers its background server to generate a QPlusID according to information such as the platform login account of the user terminal and the AppID of the third party application.

Step 202: the open platform account is sent to the third party application.

After the open platform acquires the QPlusID associating the third party application with the user terminal, the open platform notifies the third party application to acquire the QPlusID. After the third party application acquires through the front end the QPlusID transmitted from the open platform, the third party application logs in a background server of the third party application and transmits the acquired QPlusID to the background server of the third party application for saving. The background server of the third party application also saves the corresponding relationship between the login account of the user terminal on the third party application (that is, the third party login account referred in this embodiment) and the QPlusID, so that the third party application can provide the QPlusID to the open platform when needing the open platform to transmit a prompt message to the user terminal.

Step 203: a notification instruction sent by the third party application is received, and a prompt message corresponding to the notification is sent, on behalf of the third party application, to the user terminal according to the open platform account carried in the notification instruction.

At a certain moment, when the background server of the third party application needs to notify the front end of the third party application, the front end of the third party application might be in an online state or an offline state. The background server of the third party application searches out from a locally saved list the QPlusID corresponding to the third party login account of the user terminal and specifies the corresponding QPlusID when making a request to an interface of the prompt centre of the open platform. The prompt centre of the open platform inquires the background server of the open platform about the platform login account of the user terminal and the AppID of the third party application, in this way, the prompt centre of the open platform learns the destination of the prompt message, and verifies whether the AppID of the third party application is correct, so as to prevent malicious access or interference caused by cross-platform application.

During specific implementation, as shown in FIG. 3, Step 203 serving as an implementation where the open platform performs message prompt includes the following steps.

Step 2031: the open platform searches locally for the platform login account of the user terminal corresponding to the open platform account carried in the notification instruction.

The open platform searches locally for the platform login account of the user terminal corresponding to the QPlusID provided by the third party application.

Step 2032: a prompt message corresponding to the notification instruction is sent to the user terminal according to the platform login account of the user terminal.

As shown in FIG. 4, Step 203 serving as another implementation where the open platform performs message prompt includes the following steps.

Step 2033: the open platform searches locally for the platform login account of the user terminal and the AppID of the third party application corresponding to the open platform account carried in the notification instruction.

The open platform searches locally for the platform login account of the user terminal and the AppID of the third party application corresponding to the QPlusID provided by the third party application.

Step 2034: verification is performed on the AppID of the third party application.

Step 2035: a prompt message corresponding to the notification instruction is sent to the user terminal according to the platform login account of the user terminal, after the verification succeeds.

In this embodiment, after the user terminal logs in the open platform, if the user terminal initiates the third party application, then the open platform sends to the third party application the open platform account which is generated according to the AppID of the third party application and the platform login account of the user terminal. When the third party application needs to send a notification to the user, the open platform transmits, on behalf of the third party application, a prompt message to the user according to the open platform account specified by the third party application, thus the prompt and push problem of the third party application is solved and the interference problem caused by cross-platform application is avoided.

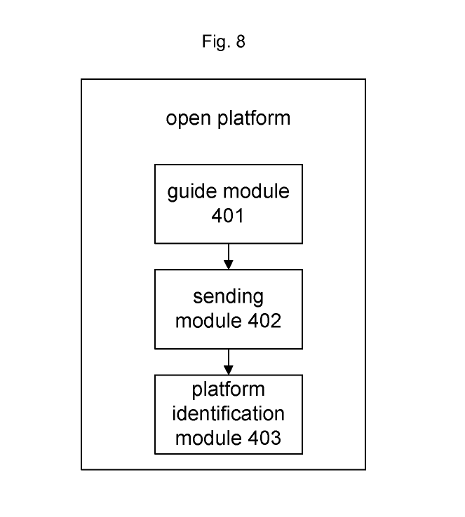

As shown in FIG. 8, a first embodiment of the disclosure provides an open platform, which includes: a guide module 401, a sending module 402 and a platform identification module 403.

The guide module 401 is configured to enter a page to receive an authorization instruction for a third party application from a user terminal.

The sending module 402 is configured to send a first OpenID and a first OpenKey of the user terminal to the third party application according to a preset login rebound protocol of the open platform when the connection of authorization of the user terminal succeeds, so that the third party application performs user-terminal-based login according to the first OpenID and the first OpenKey.

The platform identification module 403 is configured to send a prompt message to the user terminal with an open platform account serving as an identification of the open platform, when the user terminal logging into the open platform initiates the third party application.

Specifically, in this embodiment, the page that the open platform enters is an authorization page. The open platform may enter the authorization page according to an application login instruction of the user terminal. The application login instruction might be a voice instruction, also might be a control set by the open platform for allowing the user terminal to access the third party application, for example, the user might click an APP application button of a client to enter the authorization page. Alternatively, the user terminal may log in the third party application (for example, the user enters the third party application by clicking a login button on the third party application) and then the third party application calls an interface of the open platform, so as to make the open platform enter the authorization page, wherein the interface might be a js API.

After the open platform enters the authorization page, the guide module 401 guides the user to agree to authorize the third party application.

When the user terminal agrees the authorization and the connection of authorization of the user terminal succeeds, the open platform opens, according to a preset login rebound protocol of the open platform, a login success page of the third party application to notify the third party application that the user terminal agrees the authorization; meanwhile, the open platform sends the first OpenID and the first OpenKey to the third party application through the sending module 402.

After the third party application receives the first OpenID and the first OpenKey sent from the open platform, the third party application performs authorization login. After the authorization login succeeds, the third party application sends a login status, so as to allow the user to access resources provided by the third party application and allow the user to enjoy services provided by the third party application.

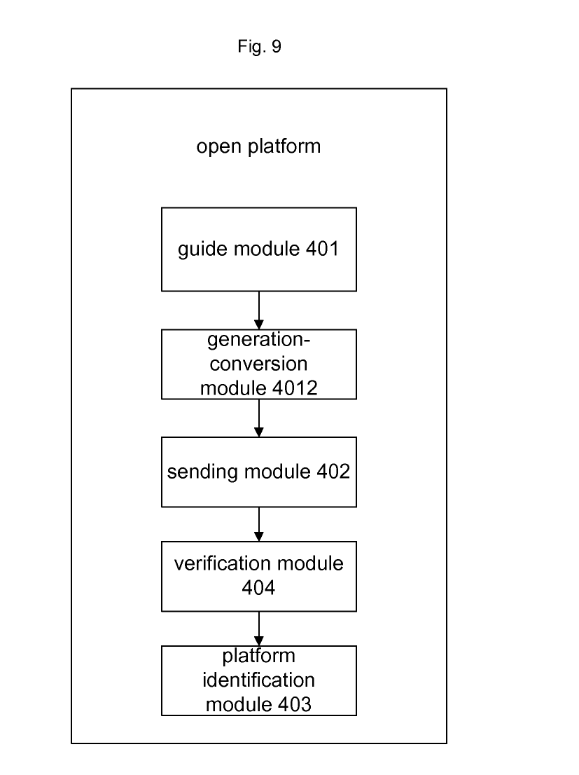

As shown in FIG. 9, the second embodiment of the disclosure provides an open platform, which further includes a generation-conversion module 4012 and a verification module 404 on the basis of the first embodiment.

The generation-conversion module 4012 is connected between the guide module 401 and the sending module 402 and is configured to generate an initial OpenID and an initial OpenKey according to a login account of the user terminal, and to convert the initial OpenID and the initial OpenKey into the first OpenID and the first OpenKey correspondingly according to a preset mapping relationship.

The verification module 404 is connected with the sending module 402 and is configured to perform verification on the third party application according to the first OpenID and the first OpenKey; if the verification succeeds, it is indicated the authorized login of the third party application succeeds.

Further, the verification module 404 is also configured to receive a verification request sent from the third party application, the verification request carrying the first OpenID and the first OpenKey; to verify the first OpenID and the first OpenKey carried in the verification request and to return user authorization data to the third party application after the verification succeeds.

The difference between the second embodiment and the first embodiment lies in that: in the second embodiment, the first OpenID and the first OpenKey sent to the third party application by the open platform are converted from the initial OpenID and the initial OpenKey through a preset mapping relationship.

Specifically, after the user terminal logs in and the guide module 401 guides the user terminal to agree to authorize the third party application, the open platform generates the initial OpenID and the initial OpenKey according to the login account of the user terminal through the generation-conversion module 4012; and then the generation-conversion module 4012 converts the initial OpenID and the initial OpenKey into the first OpenID and the first OpenKey correspondingly according to the preset mapping relationship, thereby enhancing the safety of the third-party authorized login.

In addition, in this embodiment, after the third party application receives the first OpenID and the first OpenKey from the open platform, the third party application performs validity authentication according to the first OpenID and the first OpenKey, wherein the specific authentication process includes two conditions as follows.

The first condition is that: the third party application performs the validity authentication locally; specifically, the third part application is subject to the validity authentication on the first OpenID and the first OpenKey by a local server.

The second condition is that: the third party application is subject to the validity authentication on the first OpenID and the first OpenKey by the open platform; specifically, the authentication on the first OpenID and the first OpenKey is performed through the verification module 404 of the open platform.

In the second condition above, the authentication process specifically includes: the third party application sends to the open platform a verification request which carries the first OpenID and the first OpenKey, and then the open platform performs the validity verification on the first OpenID and the first OpenKey included in the verification request transmitted from the third party application; after the verification succeeds, it is indicated that the authorized login of the third party application succeeds, and the third party application transmits a login status, allows the user terminal to access resources provided by the third party application and allows the user terminal to enjoy services provided by the third party application.

During the process where the third party application is subject to the validity authentication on the first OpenID and the first OpenKey by the open platform, if the third party application needs to acquire the authorization data of the user, then the third party application carries through the local server the first OpenID and the first OpenKey to the background server of the open platform to acquire the authorization data of the user; after the open platform successfully authenticates the validity of the first OpenID and the first OpenKey, the open platform returns the authorization data of the user to the third party application.

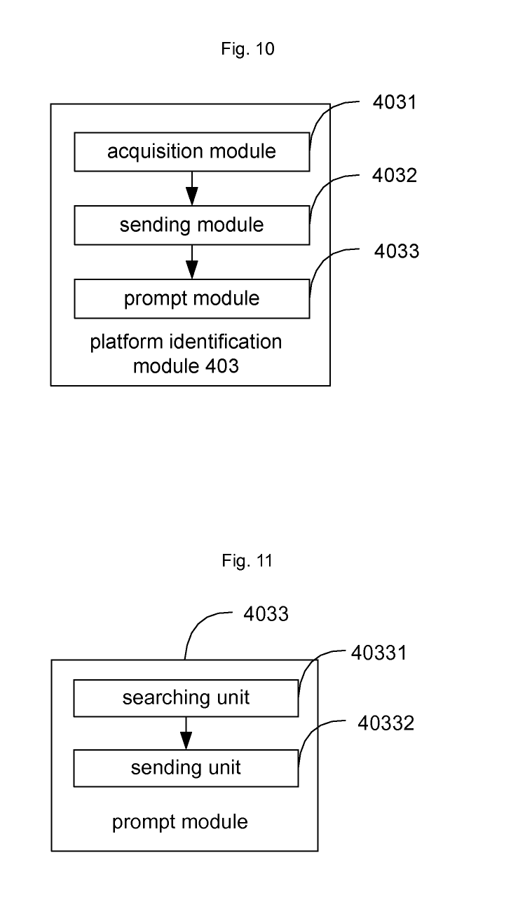

The platform identification module 403, as shown in FIG. 10, includes an acquisition module 4031, a sending module 4032 and a prompt module 4033.

The acquisition module 4031 is configured to acquire an open platform account which is generated according to an AppID of a third party application and a platform login account of a user terminal, when the user terminal logging into the open platform initiates the third party application.

The sending module 4032 is configured to send the open platform account to the third party application.

The prompt module 4033 is configured to receive a notification instruction sent by the third party application, and to send, on behalf of the third party application, a prompt message corresponding to the notification instruction to the user terminal according to the open platform account carried in the notification instruction.

In this embodiment, the open platform might be an instant communication open platform, for example, QQ open platform and the like. The user logs in the open platform through the platform login account on a PC or a mobile phone (an IPhone). The platform login account serves as the identification for allowing the user to log in the open platform. After the user logs in the open platform, the user may click a third party application running on this open platform based on actual needs, so as to acquire corresponding services or resources.

In order to identify the open platform, an embodiment sets a parameter, i.e. an open platform account (hereinafter expressed as QplusID) associating the third party application with the user terminal. This parameter QPlusID is generated by the open platform according to the platform login account of the user terminal and the AppID of the third party application.

Each user terminal has a platform login account on the open platform. The third party application on each open platform has a corresponding AppID. The QPlusID generated by the open platform according to the platform login account of the user terminal and the AppID of the third party application serves as the identification of the open platform, so that the third party application can send a message to the corresponding open platform according to the QPlusID when it wants to make a prompt through the open platform.

The QPlusID generated by the open platform according to the platform login account of the user terminal and the AppID of the third party application may be generated in advance and saved in a local cache, or may be generated temporarily.

After the user terminal logs in the open platform and initiates the third party application, if the cache of the open platform has a corresponding QPlusID, then the open platform acquires the corresponding QPlusID directly through the acquisition module 4031; if the cache has no corresponding QPlusID, then the open platform triggers its background server through the acquisition module 4031 to generate a QPlusID according to information such as the platform login account of the user terminal and the AppID of the third party application.

After the open platform acquires the QPlusID associating the third party application with the user terminal, the open platform notifies the third party application to acquire the QPlusID and sends the QPlusID to the third party application through the sending module 4032. After the third party application acquires through its front end the QPlusID sent from the open platform, the third party application logs in a background server of the third party application and sends the acquired QPlusID to the background server of the third party application for saving. The background server of the third party application also saves the relationship between the login account of the user terminal on the third party application (that is, the third party login account referred in this embodiment) and the QPlusID, so that the third party application can provide the QPlusID to the open platform when needing the open platform to transmit a prompt message to the user terminal.

The open platform may adopt a preset algorithm to generate the QPlusID according to the platform login account of the user terminal and the AppID of the third party application. For example, the open platform can concatenate the platform login account of the user terminal and the AppID of the third party application together to generate the QPlusID, through existing symmetrical encryption algorithms such as TEA, DES and IDEA. The above symmetrical encryption algorithms belong to existing mature schemes and no further description is repeated here.

At a certain point, when the background server of the third party application needs to notify the front end of the third party application, the front end of the third party application might be in an online state or an offline state. The background server of the third party application searches out from a locally saved list the QPlusID corresponding to the third party login account of the user terminal and specifies the corresponding QPlusID when making a request to an interface of the prompt centre of the open platform; The prompt module 4033 of the open platform inquires, through the prompt centre, the background server of the open platform about the platform login account of the user terminal and the AppID of the third party application, in this way, the prompt centre of the open platform learns the destination of the prompt message, and verifies whether the AppID of the third party application is correct, so as to prevent malicious access or interference caused by cross-platform application.

During specific implementation, as shown in FIG. 11, in an embodiment, the prompt module 4033 includes: a searching unit 40331 and a sending unit 40332.

The search unit 40331 is configured to search locally for the platform login account of the user terminal corresponding to the open platform account carried in the notification instruction.

The transmitting unit 40332 is configured to send a prompt message corresponding to the notification instruction to the user terminal according to the platform login account of the user terminal.

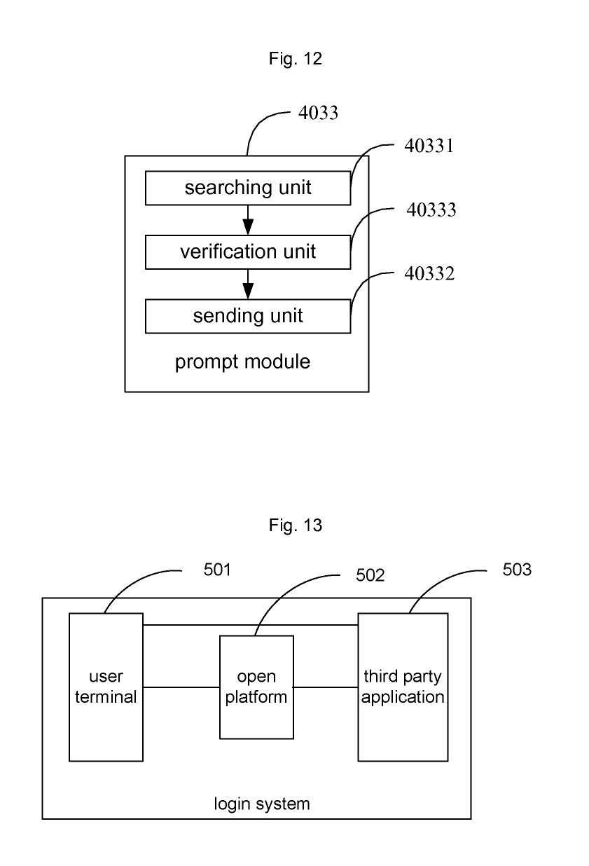

As shown in FIG. 12, in another embodiment, the prompt module 4033 includes a searching unit 40331, a sending unit 40332 and a verification unit 40333.

in this embodiment, the searching unit 40331 is configured to search locally for the platform login account of the user terminal and the AppID of the third party application corresponding to the open platform account carried in the notification instruction.

The verification unit 40333 is configured to verify the AppID of the third party application.

The sending unit 40332 is further configured to send a prompt message corresponding to the notification instruction to the user terminal according to the platform login account of the user terminal, after the verification succeeds.

The disclosure also provides an open platform, which includes a platform identification module 403, wherein the platform identification module 403, as shown in FIG. 10, includes: an acquisition module 4031, a sending module 4032 and a prompt module 4033.

The acquisition module 4031 is configured to acquire an open platform account which is generated according to an AppID of a third party application and a platform login account of a user terminal, when the user terminal logging into the open platform initiates the third party application.

The sending module 4032 is configured to send the open platform account to the third party application.

The prompt module 4033 is configured to receive a notification instruction sent by the third party application, and to send, on behalf of the third party application, a prompt message corresponding to the notification instruction to the user terminal according to the open platform account carried in the notification instruction.

In this embodiment, the open platform might be an instant communication open platform, for example, QQ open platform and the like. The user logs in the open platform through the platform login account on a PC or a mobile phone (an IPhone). The platform login account serves as the identification for allowing the user to log in the open platform. After the user logs in the open platform, the user may click a third party application running on this open platform based on actual needs, so as to acquire corresponding services or resources.

In order to identify the open platform, an embodiment sets a parameter, i.e. an open platform account (hereinafter expressed as QplusID) associating the third party application with the user terminal. This parameter QPlusID is generated by the open platform according to the platform login account of the user terminal and the AppID of the third party application.

Each user terminal has a platform login account on the open platform. The third party application on each open platform has a corresponding AppID. The QPlusID generated by the open platform according to the platform login account of the user terminal and the AppID of the third party application serves as the identification of the open platform, so that the third party application can send a message to the corresponding open platform according to the QPlusID when it wants to make a prompt through the open platform.

The QPlusID generated by the open platform according to the platform login account of the user terminal and the AppID of the third party application may be generated in advance and saved in a local cache, or may be generated temporarily.

After the user terminal logs in the open platform and initiates the third party application, if the cache of the open platform has a corresponding QPlusID, then the open platform acquires the corresponding QPlusID directly through the acquisition module 4031; if the cache has no corresponding QPlusID, then the open platform triggers its background server through the acquisition module 4031 to generate a QPlusID according to information such as the platform login account of the user terminal and the AppID of the third party application.

After the open platform acquires the QPlusID associating the third party application with the user terminal, the open platform notifies the third party application to acquire the QPlusID and sends the QPlusID to the third party application through the sending module 4032. After the third party application acquires through its front end the QPlusID sent from the open platform, the third party application logs in a background server of the third party application and sends the acquired QPlusID to the background server of the third party application for saving. The background server of the third party application also saves the relationship between the login account of the user terminal on the third party application (that is, the third party login account referred in this embodiment) and the QPlusID, so that the third party application can provide the QPlusID to the open platform when needing the open platform to transmit a prompt message to the user terminal.

The open platform may adopt a preset algorithm to generate the QPlusID according to the platform login account of the user terminal and the AppID of the third party application. For example, the open platform can concatenate the platform login account of the user terminal and the AppID of the third party application together to generate the QPlusID, through existing symmetrical encryption algorithms such as TEA, DES and IDEA. The above symmetrical encryption algorithms belong to existing mature schemes and no further description is repeated here.

At a certain point, when the background server of the third party application needs to notify the front end of the third party application, the front end of the third party application might be in an online state or an offline state. The background server of the third party application searches out from a locally saved list the QPlusID corresponding to the third party login account of the user terminal and specifies the corresponding QPlusID when making a request to an interface of the prompt centre of the open platform; The prompt module 4033 of the open platform inquires, through the prompt centre, the background server of the open platform about the platform login account of the user terminal and the AppID of the third party application, in this way, the prompt centre of the open platform learns the destination of the prompt message, and verifies whether the AppID of the third party application is correct, so as to prevent malicious access or interference caused by cross-platform application.

During specific implementation, as shown in FIG. 11, in an embodiment, the prompt module 4033 includes: a searching unit 40331 and a sending unit 40332.

The search unit 40331 is configured to search locally for the platform login account of the user terminal corresponding to the open platform account carried in the notification instruction.

The transmitting unit 40332 is configured to send a prompt message corresponding to the notification instruction to the user terminal according to the platform login account of the user terminal.

As shown in FIG. 12, in another embodiment, the prompt module 4033 includes a searching unit 40331, a sending unit 40332 and a verification unit 40333.

in this embodiment, the searching unit 40331 is configured to search locally for the platform login account of the user terminal and the AppID of the third party application corresponding to the open platform account carried in the notification instruction.

The verification unit 40333 is configured to verify the AppID of the third party application.

The sending unit 40332 is further configured to send a prompt message corresponding to the notification instruction to the user terminal according to the platform login account of the user terminal, after the verification succeeds.

As shown in FIG. 13, an preferred embodiment of the disclosure provides a login system, which includes: a user terminal 501, an open platform 502 and a third party application 503.

The user terminal 501 is configured to link to the open platform 502 and to send an authorization instruction for the third party application 503 to the open platform 502, and to receive access resources and services provided by the third party application 503 after the authorized login of the third party application 503 succeeds.

The open platform 502 is configured to enter a page to receive the authorization instruction for the third party application 503 from the user terminal, to send a first OpenID and a first OpenKey of the user terminal to the third party application 503 according to a preset login rebound protocol of the open platform 502 when the connection of authorization of the user terminal 501 succeeds, and to send a prompt message to the user terminal 501 with an open platform account serving as an identification of the open platform 502 when the user terminal logging into the open platform 502 initiates the third party application.

The third party application 503 is configured to receive the first OpenID and the first OpenKey sent by the open platform 502, to send a login status according to the first OpenID and the first Open Key, so as to allow the user terminal to access resources of the third party application 503 and provide site services for the user terminal.

Further, the open platform 502 may be further configured to verify the validity of the third party application 503 according to the first OpenID and the first OpenKey; if the verification succeeds, it is indicated the authorized login of the third party application 503 succeeds.

The third party application 503 may be further configured to be subject to validity verification on the first OpenID and the first OpenKey by a local server according, or, the third party application 503 may be configured to be subject to the validity verification on the first OpenID and the first OpenKey by the open platform 502.

When the third party application 503 is subject to the validity verification on the first OpenID and the first OpenKey by the open platform 502, the third party application 503 may be further configured to send to the open platform 502 a verification request to acquire user authorization data, the verification request carrying the first OpenID and the first OpenKey, and to receive the user authorization data returned after the open platform 502 verifies the OpenID and the first OpenKey are valid.

In this embodiment, the open platform 502 may enter an authorization page according to an application login instruction of the user terminal 501. Alternatively, the user terminal 501 may log in the third party application 503 and the third party application 503 calls a js API of the open platform 502, so as to make the open platform 502 enter the authorization page. For the latter condition, the third party application 503 receives a login instruction of the user terminal 501 and calls, according to the login instruction, a corresponding interface such as js API of the open platform 502 to open the authorization page of the open platform 502.

After the open platform 502 enters the authorization page, the open platform 502 guides the user terminal to agree to authorize the third party application 503.

When the user terminal 501 agrees the authorization and the connection of authorization of the user terminal succeeds, the open platform 502 opens, according to a preset login rebound protocol of the open platform 502, a login success page of the third party application 503 to notify the third party application 503 that the user terminal 501 agrees the authorization; meanwhile, the first OpenID and the first OpenKey are brought to the third party application 503 by the open platform 502.

The first OpenID and the first OpenKey sent to the third party application 503 by the open platform 502 may be the initial OpenID and the initial OpenKey acquired after the open platform 502 guides the user terminal 501 to agree the authorization, also may be converted though a preset mapping relationship from the initial OpenID and the initial OpenKey acquired by the open platform 502.

Specifically, after the user terminal 501 logs in and the open platform 502 guides the user terminal 501 to agree to authorize the third party application 503, the open platform 502 generates the initial OpenID and the initial OpenKey according to the login account of the user terminal 501, and converts the initial OpenID and the initial OpenKey into the first OpenID and the first OpenKey according to the preset mapping relationship, thereby enhancing the safety of the third-party authorized login.

After the third party application 503 receives the first OpenID and the first OpenKey from the open platform 502, the third party application performs validity authentication according to the first OpenID and the first OpenKey, wherein the specific authentication process includes two conditions as follows.

The first condition is that: the third party application 503 performs the validity authentication locally; specifically, the third party application is subject to the validity authentication on the first OpenID and the first OpenKey by a local server.

The second condition is that: the third party application 503 is subject to the validity authentication on the first OpenID and the first OpenKey by the open platform 502.

In the second condition above, the authentication process specifically includes: the third party application 503 sends to the open platform a verification request which carries the first OpenID and the first OpenKey, and then the open platform 502 performs the validity verification on the first OpenID and the first OpenKey included in the verification request from the third party application 503; after the verification succeeds, it is indicated that the authorized login of the third party application 503 succeeds, and the third party application 503 sends a login status, so as to allow the user terminal 501 to access resources provided by the third party application 503 and allow the user terminal 501 to enjoy services provided by the third party application 503.

During the process where the third party application 503 is subject to the validity authentication on the first OpenID and the first OpenKey by the open platform 502, if the third party application 503 needs to acquire the authorization data of the user, then the third party application 503 carries through the local server the first OpenID and the first OpenKey to the background server of the open platform 502 to acquire the authorization data of the user; after the open platform 502 successfully authenticates the validity of the first OpenID and the first OpenKey, the open platform 502 returns the authorization data of the user to the third party application 503.

When the user terminal logging into the open platform 502 initiates the third party application, the open platform 502 acquires an open platform account which is generated according to an AppID of the third party application and a platform login account of the user terminal, sends the open platform account to the third party application 503, receives a notification instruction sent by the third party application 503, and sends on behalf of the third party application 503 a prompt message corresponding to the notification instruction to the user terminal 501 according to the open platform account carried in the notification instruction.

Correspondingly, the third party application 503 receives the open platform account sent by the open platform 502 and records the relationship between the third party login account of the user terminal 501 and the QPlusID, when the user terminal logs in the third party application 503; and acquires the corresponding open platform account according to the third party login account of the user terminal 501 and provides a notification to the open platform 502 when the third party application 503 needs to send the notification to the user terminal 501.

With the login method, the open platform and the open platform system provided by the embodiments of the disclosure, a user terminal is guided to agree to authorize a third party application through a page of the open platform; when the connection of authorization of the user terminal succeeds, the open platform brings a first OpenID and a first OpenKey of the user terminal to the third party application according to a login rebound protocol of the open platform, and then validity verification is performed on the third party application according to the first OpenID and the first OpenKey. After the verification succeeds, it is indicated that the authorized login of the third party application succeeds; and thus login can be implemented in various forms. Therefore, the user does not need to register or manage login accounts of a plurality of websites, but needs one registered account on an open platform only to access a plurality of websites after authorization, and thus convenience is provided to the user. Moreover, after the user terminal logs in the open platform, if the user terminal initiates the third party application, the open platform sends to the third party application an open platform account which is generated according to the AppID of the third party application and the platform login account of the user terminal. When the third party application needs to send a notification to the user, the open platform sends, on behalf of the third party application, a corresponding prompt message to the user according to the open platform account specified by the third party application, thus the prompt and push problem of the third party application is solved and the interference problem caused by cross-platform application is prevented.

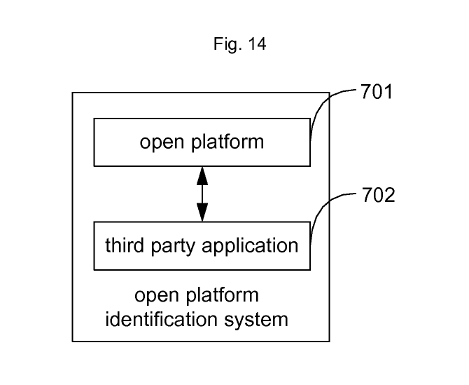

As shown in FIG. 14, an embodiment of the disclosure provides an open platform identification system, which includes an open platform 701 and a third party application 702.

The open platform 701 is configured to: acquire an open platform account which is generated according to an AppID of the third party application 702 and a platform login account of a user terminal, when the user terminal logging into the open platform 701 initiates the third party application 702; send the acquired open platform account to the third party application 702. When the third party application 702 needs to send a notification to the user terminal, the open platform 701 receives a notification instruction sent by the third party application 702, and sends on behalf of the third party application 702 a prompt message corresponding to the notification instruction to the user terminal according to the open platform account carried in the notification instruction.

The third party application 702 is configured to: receive the open platform account sent by the open platform 701 and record a relationship between the third party login account of the user terminal and the QPlusID, when the user terminal logs in the third party application 702. When the third party application 702 needs to send the notification to the user terminal, the third party application 702 acquires the open platform account according to the third party login account of the user terminal and provide the notification to the open platform 701.

The open platform 701 mentioned in this embodiment may be the open platform 502 mentioned in any one of above embodiments, and the third party application 702 may be the third party application 503 in any one of the above embodiment. In examples of the disclosure, the open platform is identified through the open platform account, so as to implement the message prompt of the third party application, the process of which can be referred to the above embodiments, and no further description is repeated here.

The above are only preferred embodiments of the disclosure and are not intended to limit the scope of the disclosure. Any equivalent structures or equivalent flow modifications made according to the description and the accompanying drawings of the disclosure, or any equivalent structures or equivalent flow modifications applied in other relevant technical fields directly or indirectly are deemed to be included in the scope of the disclosure.

1. A login method, comprising:
entering, by an open platform, a page to receive an authorization instruction for a third party application from a user terminal;
when connection of authorization of the user terminal succeeds, sending a first login identification (OpenID) and a first login key (OpenKey) of the user terminal to the third party application according to a preset login rebound protocol of the open platform; and
performing, by the third party application, user-terminal-based authorized login according to the first OpenID and the first Open Key; and
when the user terminal logging into the open platform initiates the third party application, sending a prompt message to the user terminal with an open platform account serving as an identification of the open platform.

2. The login method according to claim 1, further comprising:
after the step of sending the first OpenID and the first OpenKey of the user to the third party application,
verifying the validity of the third party application according to the first OpenID and the first OpenKey, when the verification succeeds, it is indicated the authorized login of the third party application succeeds.

3. The login method according to claim 2, wherein the step of verifying the validity of the third party application according to the first OpenID and the first OpenKey comprises:
receiving a verification request sent from the third party application, wherein the verification request carries the first OpenID and the first OpenKey; and
verifying the validity of the first OpenID and the first OpenKey carried in the verification request.

4. The login method according to claim 3, further comprising:
after the verification succeeds, returning, by the open platform, user authorization data to the third party application.

5. The login method according to claim 3, further comprising:
before the step of sending the first OpenID and the first OpenKey of the user terminal to the third party application according to the preset login rebound protocol of the open platform,
generating, by the open platform, an initial OpenID and an initial OpenKey according to a login account of the user terminal; and
according to a preset mapping relationship, converting the initial OpenID and the initial OpenKey into the first OpenID and the first OpenKey correspondingly.

6. The login method according to claim 1, wherein the open platform enters the page according to an application login instruction of the user terminal; or
wherein the user terminal logs in the third party application and the third party application calls an interface of the open platform, so as to make the open platform enter the page.

7. The login method according to claim 1, wherein when the user terminal logging into the open platform initiates the third party application, sending the prompt message to the user terminal with the open platform account serving as the identification of the open platform comprises:
when the user terminal logging into the open platform initiates the third party application, acquiring by the open platform the open platform account which is generated according to an application ID (AppID) of the third party application and a platform login account of the user terminal;
sending the open platform account to the third party application;
receiving a notification instruction sent by the third party application; and
sending, on behalf of the third party application, a prompt message corresponding to the notification instruction to the user terminal according to the open platform account carried in the notification instruction.

8. An open platform, comprising: a guide module, a sending module and a platform identification module,
wherein the guide module is configured to enter a page to receive an authorization instruction for a third party application from a user terminal,
wherein the sending module is configured to send a first OpenID and a first OpenKey of the user terminal to the third party application according to a login rebound protocol of the open platform when connection of authorization of the user terminal succeeds, so that the third party application performs user-terminal-based authorized login according to the first OpenID and the first OpenKey, and
the platform identification module is configured to send a prompt message to the user terminal with an open platform account serving as an identification of the open platform, when the user terminal logging into the open platform initiates the third party application.

9. The open platform according to claim 8, further comprising:
a verification module, which is configured to verify the validity of the third party application according to the first OpenID and the first OpenKey, when the verification succeeds, it is indicated the authorized login of the third party application succeeds.

10. The open platform according to claim 9, wherein the verification module is further configured to receive a verification request sent from the third party application, the verification request carrying the first OpenID and the first OpenKey, and to verify the validity of the first OpenID and the first OpenKey carried in the verification request.

11. The open platform according to claim 10, wherein the verification module is further configured to return user authorization data to the third party application after the verification succeeds.

12. The open platform according to claim 8, further comprising:
a generation-conversion module, which is configured to generate an initial OpenID and an initial OpenKey according to a login account of the user terminal, and to convert the initial OpenID and the initial OpenKey into the first OpenID and the first OpenKey correspondingly according to a preset mapping relationship.

13. The open platform according to claim 8, wherein the platform identification module comprises: an acquisition module, a sending module and a prompt module,
wherein the acquisition module is configured to acquire an open platform account which is generated according to an AppID of the third party application and a platform login account of the user terminal, when the user terminal logging into the open platform initiates the third party application,
wherein the sending module is configured to send the open platform account to the third party application, and
wherein the prompt module is configured to receive a notification instruction sent by the third party application, and to send, on behalf of the third party application, a prompt message corresponding to the notification to the user terminal according to the open platform account carried in the notification instruction.

14. A login system, comprising: a user terminal, an open platform and a third party application,
wherein the user terminal is configured to link to the open platform and to send an authorization instruction for the third party application to the open platform, and to receive access resources and services provided by the third party application when the authorized login of the third party application succeeds,
wherein the open platform is configured to enter a page to receive the authorization instruction for the third party application from the user terminal, to send a first OpenID and a first OpenKey of the user terminal to the third party application according to a preset login rebound protocol of the open platform when connection of authorization of the user terminal succeeds, and to send a prompt message to the user terminal with an open platform account serving as an identification of the open platform when the user terminal logging into the open platform initiates the third party application, and
wherein the third party application is configured to receive the first OpenID and the first OpenKey sent by the open platform, to send a login status according to the first OpenID and the first OpenKey, so as to allow the user terminal to access resources of the third party application and provide site services for the user terminal.

15. The system according to claim 14,
wherein the open platform is further configured to verify the validity of the third party application according to the first OpenID and the first OpenKey, when the verification succeeds, it is indicated the authorized login of the third party application succeeds,
wherein the third party application is further configured to be subject to validity verification on the first OpenID and the first OpenKey by a local server, or, the third party application is configured to be subject to the validity verification on the first OpenID and the first OpenKey by the open platform.

16. The system according to claim 14, wherein the third party application is further configured to send to the open platform a verification request to acquire user authorization data, the verification request carrying the first OpenID and the first OpenKey, and to receive the user authorization data returned by the open platform after the open platform verifies the OpenID and the first OpenKey are valid.

17. The system according to claim 14, wherein the third party application is further configured to receive an application login instruction from a client, and to call, according to the application login instruction, an interface of the open platform so as to open a page of the open platform.

18. The system according to claim 14, wherein the open platform is configured to: acquire an open platform account which is generated according to an AppID of the third party application and a platform login account of the user terminal, when the user terminal logging into the open platform initiates the third party application;
send the open platform account to the third party application;
receive a notification instruction sent by the third party application, and send, on behalf of the third party application, a prompt message corresponding to the notification to the user terminal according to the open platform account carried in the notification instruction.

19. An open platform identification method, comprising:
when a user terminal logging into an open platform initiates a third party application, acquiring, by the open platform, an open platform account which is generated according to an AppID of the third party application and a platform login account of the user terminal;
sending the open platform account to the third party application; and
receiving a notification instruction sent by the third party application, and send, on behalf of the third party application, a prompt message corresponding to the notification instruction to the user terminal according to the open platform account carried in the notification instruction.

20. The method according to claim 19, wherein the step of acquiring, by the open platform, the open platform account which is generated according to the AppID of the third party application and the platform login account of the user terminal comprises:
acquiring, by the open platform, the open platform account from cache; or
generating, by the open platform, a temporary open platform account through a preset algorithm according to the platform login account of the user terminal and the AppID of the third party application.

21. The method according to claim 19, wherein the step of sending, by the open platform, on behalf of the third party application, the prompt message corresponding to the notification instruction to the user terminal according to the open platform account carried in the notification instruction comprises:
by the open platform, searching locally for the platform login account of the user terminal corresponding to the open platform account carried in the notification instruction; and
sending the prompt message corresponding to the notification instruction to the user terminal according to the platform login account of the user terminal.

22. The method according to claim 19, wherein the step of sending, by the open platform, on behalf of the third party application, the prompt message corresponding to the notification instruction to the user terminal according to the open platform account carried in the notification instruction includes:
by the open platform, searching locally for the platform login account of the user terminal and the AppID of the third party application corresponding to the open platform account carried in the notification instruction; and
verifying the AppID of the third party application;
sending the prompt message corresponding to the notification instruction to the user terminal according to the platform login account of the terminal, after the verification succeeds.

23. An open platform, comprising a platform identification module, wherein the platform identification module comprises: an acquisition module, a sending module and a prompt module,
wherein the acquisition module is configured to acquire an open platform account which is generated according to an AppID of a third party application and a platform login account of a user terminal, when the user terminal logging into the open platform initiates the third party application,
wherein the sending module is configured to send the open platform account to the third party application, and
wherein the prompt module is configured to receive a notification instruction sent by the third party application, and to send, on behalf of the third party application, a prompt message corresponding to the notification instruction to the user terminal according to the open platform account carried in the notification instruction.

24. The open platform according to claim 23, wherein the acquisition module is configured to acquire the open platform account from cache, or
wherein the acquisition module is configured to generate a temporary open platform account through a preset algorithm according to the platform login account of the user terminal and the AppID of the third party application.

25. The open platform according to claim 23, wherein the prompt module comprises:
a searching unit, configured to search locally for the platform login account of the user terminal corresponding to the open platform account carried in the notification instruction; and
a sending unit, configured to send the prompt message corresponding to the notification instruction to the user terminal according to the platform login account of the user terminal.

26. The open platform according to claim 25, wherein the prompt module further comprises a verification unit,
wherein the searching unit is further configured to search locally for the platform login account of the user terminal and the AppID of the third party application corresponding to the open platform account carried in the notification instruction,
wherein the verification unit is configured to verify the AppID of the third party application, and
wherein the sending unit is configured to send the prompt message corresponding to the notification instruction to the user terminal according to the platform login account of the user terminal, after the verification succeeds.

27. An open platform identification system, comprising an open platform and a third party application,
wherein the open platform is configured to: acquire an open platform account which is generated according to an AppID of the third party application and a platform login account of a user terminal, when the user terminal logging into the open platform initiates the third party application; send the open platform account to the third party application; receive a notification instruction sent by the third party application, and send, on behalf of the third party application, a prompt message corresponding to the notification instruction to the user terminal according to the open platform account carried in the notification instruction,
wherein the third party application is configured to: receive the open platform account sent by the open platform and record a relationship between the third party login account of the user terminal and the open platform account, when the user terminal logs in the third party application; acquire the open platform account according to the third party login account of the user terminal and provide a notification to the open platform, when the third party application needs to send the notification to the user terminal.

28. The system according to claim 27, wherein the open platform is the one according to claim 23.
